(19) United States
(12) Patent Application Publication
(10) Pub. No.: US 2024/0199405 A1
(43) Pub. Date: Jun. 20, 2024

(54) WATER DISPENSER WITH AN IOT (INTERNET-OF-THINGS) NON-SPILL BODY WITH LOAD CELLS

(71) Applicant: Global Trade Works, LLC, Rancho Santa Margarita, CA (US)

(72) Inventors: Sze-How Lee, Rancho Santa Margarita, CA (US); Liq Jye Cheong, Rancho Santa Margarita, CA (US); Stephen Quoc Tran, Rancho Santa Margarita, CA (US); Anthony A. Pignone, JR., Rancho Santa Margarita, CA (US)

(21) Appl. No.: 18/085,416

(22) Filed: Dec. 20, 2022

(51) Int. Cl. B67D 3/00

(52) U.S. Cl. CPC B67D 3/0077; B67D 3/0032; B67D 3/0093

(57) ABSTRACT

An IOT (Internet-of-Things) non-spill body installed on a water dispenser with a water bottle is disclosed. In one embodiment, the IOT non-spill body includes a base assembly with a top cover and a base, wherein the top cover includes an indented portion where the water bottle could be placed. The IOT non-spill body also includes a plurality of load cells received in a plurality of slots on the base to sense the water bottle's weight and to output weight information. The IOT further includes a printed circuit board (PCB) coupled to the plurality of load cells to receive the weight information from the plurality of load cells, and to convert the weight information into digital weight data. In addition, the IOT includes a control board coupled to the PCB to receive the digital weight data and to use the digital weight data to determine a remaining water amount in the water bottle, and to provide a notification regarding the remaining water amount.

### FIELD

This disclosure generally relates to water dispensers, and more particularly, to a water dispenser with an IOT non-spill body with load cells.

### BACKGROUND

In general, the currently bottled water dispensers available in the market do not have the function of providing notifications of water is running out, except until when the user finds out that bottled water has run out. Furthermore, since current water dispensers do not have the ability of automatically sending out notifications of water is running out, the user needs to monitor and contact water delivery services for refill or replacement. In addition, most water dispensers available in the market are mechanical water dispensers that do not have the capacity to connect to the Internet to provide notifications through the Internet.

Therefore, there is a need for a water dispenser that could sense and provide notifications of water running out and various other status automatically through the Internet or through a display on the water dispenser itself.

### SUMMARY

An IOT (Internet-of-Things) non-spill body installed on a water dispenser with a water bottle is disclosed. In one embodiment, the IOT non-spill body includes a base assembly with a top cover and a base, wherein the top cover includes an indented portion where the water bottle could be placed. The IOT non-spill body also includes a plurality of load cells received in a plurality of slots on the base to sense the water bottle's weight and to output weight information. The IOT further includes a printed circuit board (PCB) coupled to the plurality of load cells to receive the weight information from the plurality of load cells, and to convert the weight information into digital weight data. In addition, the IOT includes a control board coupled to the PCB to receive the digital weight data and to use the digital weight data to determine a remaining water amount in the water bottle, and to provide a notification regarding the remaining water amount.

### BRIEF DESCRIPTION OF THE DRAWINGS

FIG. 1 illustrates a non-spill water dispensing system according to one exemplary embodiment.

FIG. 2A illustrates a top perspective view of the IOT non-spill body according to one exemplary embodiment.

FIG. 2B illustrates a bottom perspective view of the IOT non-spill body according to one exemplary embodiment.

FIG. 2C illustrates a front view of the IOT non-spill body according to one exemplary embodiment.

FIG. 2D illustrates a back view of the IOT non-spill body according to one exemplary embodiment.

FIG. 2E illustrates a side view of the IOT non-spill body 110 according to one exemplary embodiment.

FIG. 3 is an exploded view of the IOT non-spill body 110 according to one exemplary embodiment.

FIG. 4 is a top down perspective view of the IOT non-spill body according to one exemplary embodiment.

### DETAILED DESCRIPTION

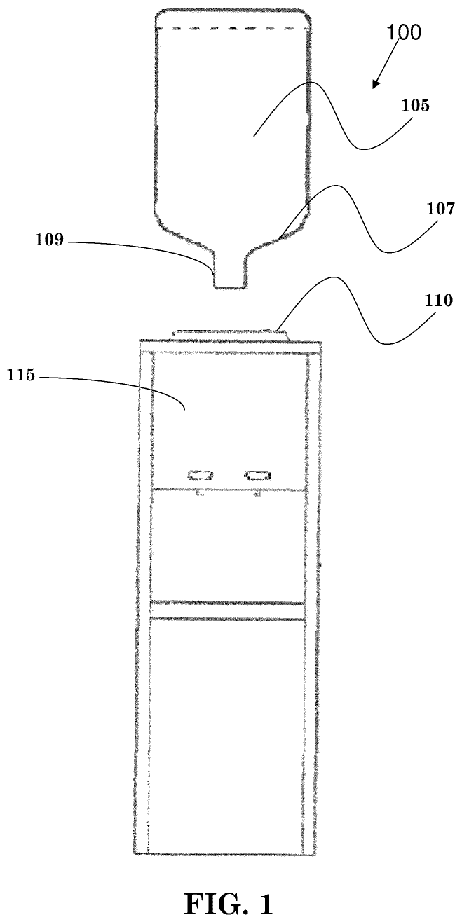

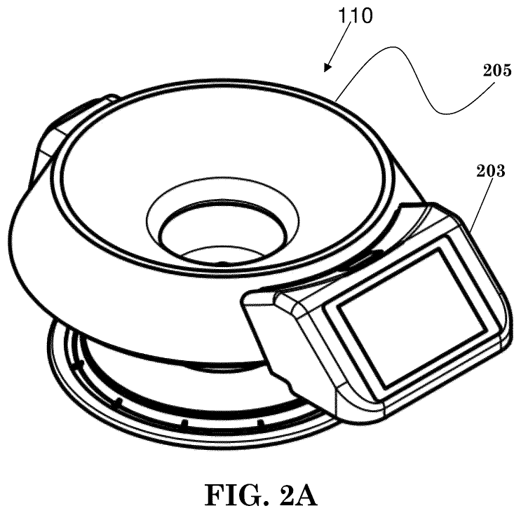

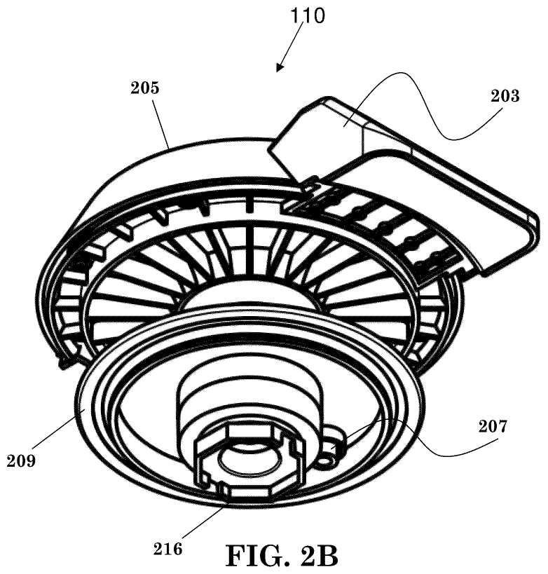

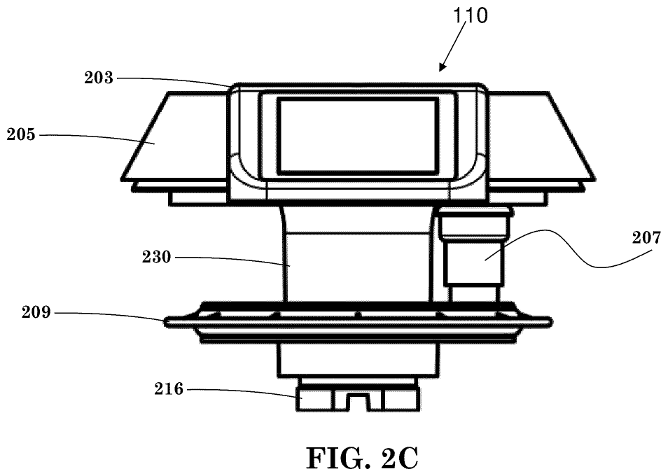

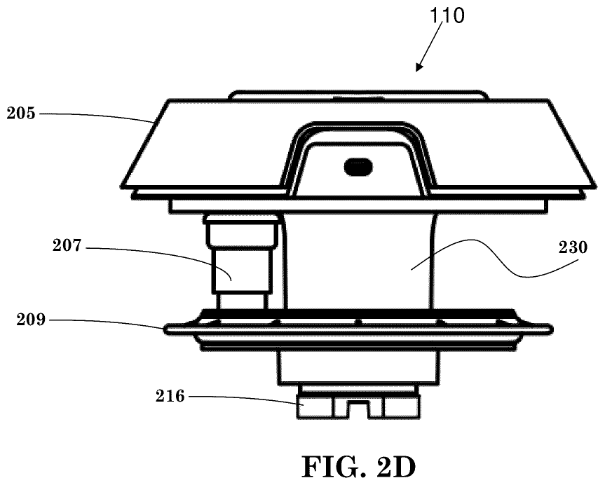

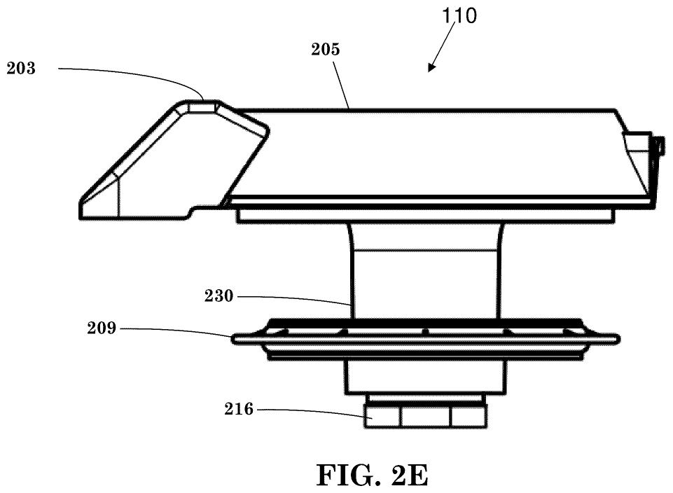

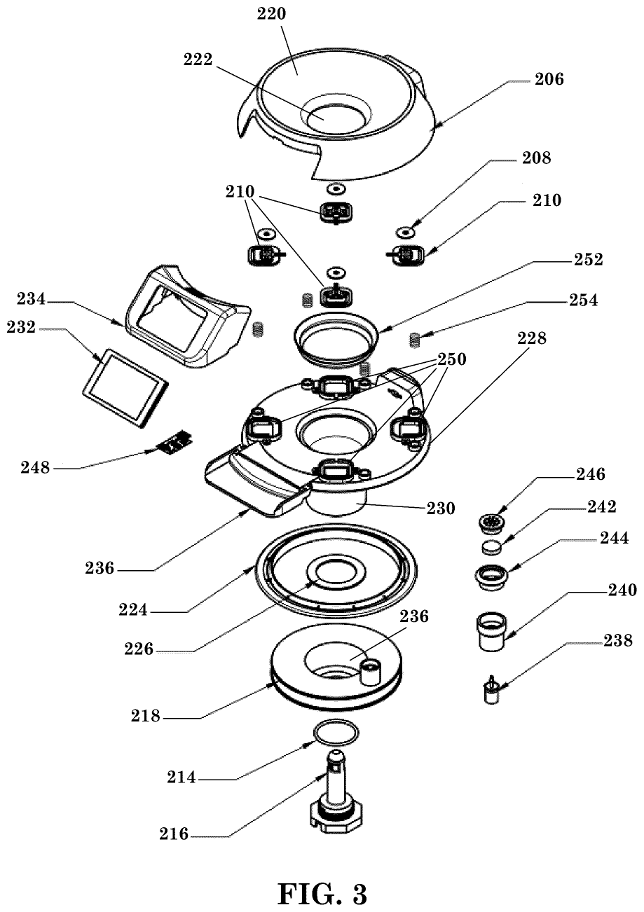

FIG. 1 illustrates a non-spill water dispensing system 100 that includes a water dispenser 115 with an IOT non-spill body 110 for placing the water bottle 105. FIGS. 2A-2E illustrate various views of the IOT non-spill body 110. In particular, FIG. 2A illustrates a top perspective view of the IOT non-spill body 110. FIG. 2B illustrates a bottom perspective view of the IOT non-spill body 110. FIG. 2C illustrates a front view of the IOT non-spill body 110. FIG. 2D illustrates a back view of the IOT non-spill body 110. FIG. 2E illustrates a side view of the IOT non-spill body 110. FIG. 3 is an exploded view of the IOT non-spill body 110, and shows various components of the non-spill body 110.

As shown in FIGS. 2A-2E, the IOT non-spill body 110 includes a base assembly 205 where the water bottle 105 could be placed or situated. The base assembly 205 has an indented top cover 206 to receive the shoulder 107 of the water bottle 105, and a hollow neck 230 to receive the neck 109 of the water bottle. The IOT non-spill body 110 also includes a flange assembly 209 coupled to the neck 230 of the base assembly 205. A feed tube 216 is inserted into the hollow neck 230 of the base assembly 205 to receive water from the water bottle 105 and to direct the received water into the water dispenser 115. The IOT non-spill body 110 further includes a check valve assembly 207, which functions as an anti-leak device to prevent water leakage. In addition, the IOT non-spill body 110 includes a monitor assembly 203 to receive and process input and commands from the users, and to communicate status (such as water bottle is empty and needs replacement) to the users.

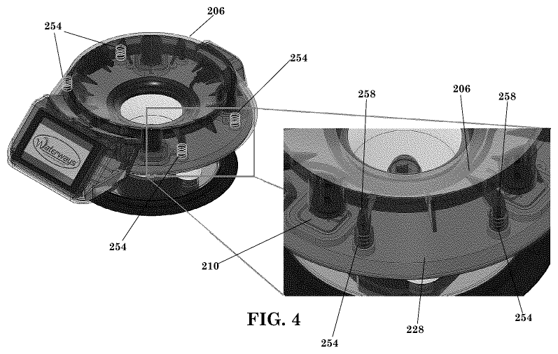

As shown in FIGS. 3 and 4, the base assembly 205 (shown in FIGS. 2A-2E) includes a top cover 206 with an indented portion 220 where the water bottle 105 (shown FIG. 1) could be placed and the water bottle's shoulder 107 (shown in FIG. 1) could be situated, and a cutout portion 222 through which the water bottle's neck 109 (shown in FIG. 1) would pass. A rubber ring 252 is placed between the top cover 206 and the base 228 to prevent water leakage. The base assembly (shown as element 205 in FIGS. 2A-2E) also includes a base 228 with slots 250 to receive load cells 210. The base 228 is coupled to the bottom of the top cover 206. The load cells 210 are situated or placed in the load cell slots 250 at strategic locations of the base 228 to sense the weight of the water bottle 105 (shown in FIG. 1) when the water bottle 105 is placed on the top cover 206. Once the load cells 210 senses the weight of the water bottle 105 (shown in FIG. 1), the amount of water remaining in the water bottle 105 could be determined or calculated based on the weight.

A printed circuit board (PCB) 248, which is signal convert board, is coupled to the load cells 210 to receive the weight data from the load cells 210, to convert the weight data into an electronic digital format. A touch screen display 232 with an integrated control board is coupled to the PCB 248 to receive the weight data in electronic digital format from the PCB 248, and to compute the remaining water amount in the water bottle 105 based on the weight data, and to communicate status and notifications (such as water bottle is empty and needs replacement) to the users through the touch screen display 232. In one embodiment, the control board of the touch screen display 232 can connect to the Internet to provide status and notifications through the Internet as well as to the touch screen display 232. In other words, the status and notifications could be communicated through the touch screen display 232 and/or through the Internet using the control board of the touch screen display 232 to the users and/or to water delivery services so that empty water bottle could be replaced or refilled.

In one embodiment, the users could enter input and commands through the touch screen display 232, and the control board of the touch screen display 232 would receive and process such input and commands. Furthermore, the control board of the touch screen display 232 can connect to the Internet to receive input and commands from the users through the Internet.

In one embodiment, washers 208 could be placed on top of the load cells 210. Furthermore, springs 254 are used to provide structural stability. As shown in FIG. 4, top cover 206 has pillars 258 that engage the base 228. Screws are inserted and fastened through the pillars to fasten the top cover 206 to the base 228. Springs 254 are placed around pillars 258 to provide structural stability.

The base 228 further includes a plate 236 to receive the monitor assembly 203 (shown in FIGS. 2A-2E). The monitor assembly 203 includes a monitor front cover 234 and a touch screen display 232. As discussed above, the touch screen display 232 includes an integrated control board. The control board of the touch screen display 232 receives the weight data (in electronic digital format) from the PCB 248, computes the remaining water amount in the water bottle 105 based on the weight data, and communicates status and notifications of the remaining water amount to the users. The notifications could be communicated through the touch screen display 232 and/or through the Internet to the users and/or to water delivery services so that empty water bottle could be replaced or refilled. Furthermore, the control board of the touch screen display 232 could receive and process input and commands from the user entered through the Internet as well as through the touch screen display.

The base 228 further includes a hollow neck 230 through which the water bottle's neck 109 (shown in FIG. 1) could pass when the water bottle 105 is placed or situated on top of the IOT non-spill body 110 (shown in FIG. 1). A flange 218 is coupled to the hollow neck 230 of the base 228. The flange 218 has a cut out portion 236 to receive the hollow neck 230 of the base 228 to allow the flange 218 to be coupled to the base 228. A rubber gasket 224 is placed around the flange 218 to prevent water leakage. In one embodiment, a silicon washer 226 is also used to prevent water leakage around the area where the flange 218 is coupled to the hollow neck 230 of the base 228.

A feed tube 216 is coupled to the flange 218 and is inserted through the flange 218 into the hollow neck 230 of the base 228. As discussed above, when the water bottle 105 (shown in FIG. 1) is placed or situated on top of the IOT non-spill body 110 (shown in FIG. 1), the feed tube 216 receives water from the water bottle 105 and directs the received water into the water dispenser 115. In one embodiment, a silicon O-ring 214 could be used where the feed tube 216 is coupled to the flange 218 to prevent water leakage.

As shown in FIGS. 2A-2E, the IOT non-spill body 110 includes a check valve assembly 207, which functions as an anti-leak device to prevent water leakage (if any). As shown in FIG. 3, the check valve assembly 207 includes a check valve 238, a filter holder 240, an air filter 242, a filter base 244, and a filter cover 246.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. While various embodiments of the invention have been described, it will be apparent to those of ordinary skill in the art that many more embodiments and implementations are possible within the scope of this invention. Moreover, various features and functionalities described in this application and Figures may be combined individually and/or plurality of features and functionalities with others. Accordingly, the invention is not to be restricted except in light of the attached claims and their equivalents, the known and customary practice within the art to which the invention pertains.

1. An IOT (Internet-of-Things) non-spill body installed on a water dispenser with a water bottle, comprising:
a base assembly with a top cover and a base, wherein the top cover includes an indented portion where the water bottle could be placed;
a plurality of load cells received in a plurality of slots on the base to sense the water bottle's weight and to output weight information;
a printed circuit board (PCB) coupled to the plurality of load cells to receive the weight information from the plurality of load cells, and to convert the weight information into digital weight data; and
a control board coupled to the PCB to receive the digital weight data and to use the digital weight data to determine a remaining water amount in the water bottle, and to provide a notification regarding the remaining water amount.

2. The IOT non-spill body of claim 1, wherein the control board is coupled to a touch screen display, and the control board provides the notification regarding the remaining water amount to users through the touch screen display.

3. The IOT non-spill body of claim 2, wherein the control board receives and processes user input and commands entered through the touch screen display.

4. The IOT non-spill body of claim 1, wherein the control board is connected to the Internet, and the control board provides the notification regarding the remaining water amount to users through the Internet.

5. The IOT non-spill body of claim 4, wherein the control board receives and processes user input and commands entered through the Internet.

6. The IOT non-spill body of claim 1, wherein the base has a generally flat surface to place the plurality of load cells to enhance weight sensing.

7. The IOT non-spill body of claim 1, wherein the base includes a hollow neck through which the water bottle's neck could pass when the water bottle is placed or situated on top of the IOT non-spill body.

8. The IOT non-spill body of claim 7, wherein the hollow neck of the base is received through a flange, and a feed tube is coupled to the flange and is inserted through the flange into the hollow neck of the base, and the feed tube receives water from the water bottle and directs the received water into the water dispenser.

9. The IOT non-spill body of claim 8, wherein a rubber gasket is placed around the flange to prevent water leakage.

10. The IOT non-spill body of claim 8, wherein a silicon O-ring is placed where the feed tube is coupled to the flange to prevent water leakage.
